(19) United States
(12) Patent Application Publication
(10) Pub. No.: US 2021/0195395 A1
(43) Pub. Date: Jun. 24, 2021

(54) RELEASE OF EMERGENCY PDN BEARER FOR A VOLTE EMERGENCY CALL WITHOUT EMERGENCY REGISTRATION

(71) Applicant: Apple Inc., Cupertino, CA (US)

(72) Inventors: Sudhir Shankar Pola, Bangalore (IN); Gaurav Bansal, Bangalore (IN); Anish George, Bangalore (IN)

(73) Assignee: Apple Inc., Cupertino, CA (US)

(21) Appl. No.: 16/755,931

(22) PCT Filed: Jul. 6, 2018
(86) PCT No.: PCT/US2018/041119

§ 371 Date: Apr. 14, 2020

Related U.S. Application Data
(60) Provisional application No. 62/572,861, filed on Oct. 16, 2017.

(51) Int. Cl. H04W 4/90; H04W 52/02; H04W 76/27; H04W 76/50

(52) U.S. Cl. CPC H04W 4/90; H04W 76/50; H04W 76/27; H04W 52/0209

(57) ABSTRACT

Techniques described herein may increase the efficiency of a network by ensuring that bearers, used in anonymous (e.g., emergency) calls are properly deactivated. A user equipment (“UE”) may maintain an inactivity timer after an emergency call has ended, and may request that the network deactivate the bearer upon expiration of the inactivity timer, if the bearer is still active upon the expiration of the inactivity timer.

### RELATED APPLICATIONS

The present application claims the benefit of U.S. Provisional Patent Application No. 62/572,861, which was filed on Oct. 16, 2017, the contents of which are hereby incorporated by reference as though fully set forth herein.

### BACKGROUND

Wireless telecommunication networks may provide emergency calling services. Emergency call services may involve establishing a Packet Data Network (“PDN”) bearer to carry the call (e.g., in Voice over Long-Term Evolution (“VoLTE”) systems) VoLTE is a feature in Long-Term Evolution (“LTE”) networks to provide voice service over a packet-switched network, and allows network providers to replace circuit-switched services. VoLTE supports emergency call services analogous to those of legacy circuit-switched calls. VoLTE allows users to make emergency calls with or without emergency registration.

### BRIEF DESCRIPTION OF THE DRAWINGS

Embodiments described herein will be readily understood by the following detailed description in conjunction with the accompanying drawings. To facilitate this description, like reference numerals may designate like structural elements. Embodiments are illustrated by way of example and not by way of limitation in the figures of the accompanying drawings.

FIG. 1 illustrates an example overview of some embodiments, in which a User Equipment (“UE”) may request the deactivation of an emergency PDN bearer (e.g., a PDN connection for emergency bearer services);

FIG. 2 illustrates an example environment in which one or more embodiments may be implemented;

FIGS. 3 and 4 illustrate an example process for deactivating an emergency PDN bearer upon a UE request, where the UE requests the deactivation based on the expiration of an inactivity timer;

FIG. 5 illustrates example components of a device in accordance with some embodiments;

FIG. 6 illustrates example interfaces of baseband circuitry in accordance with some embodiments; and

FIG. 7 is a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION OF PREFERRED EMBODIMENTS

The following detailed description refers to the accompanying drawings. The same reference numbers in different drawings may identify the same or similar elements. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Wireless telecommunications network providers may offer emergency services, whereby a UE may place an emergency call anonymously (e.g., without performing registration operations typically associated with call establishment). The call establishment may include the establishment of a PDN bearer, between a UE and a wireless telecommunications network, to carry the call (e.g., when the call is established using VoLTE or some other technique that utilizes a PDN bearer). However, typically, no mechanism exists for deactivating the PDN bearer once the call ends, which may result in one or more problems. For example, the PDN bearer remaining active may result in a wastage of network resources (e.g., processing and/or other resources consumed in keeping the PDN bearer active). Additionally, the active PDN bearer (even after the call has ended) may cause the UE to remain attached to a particular cell, even when a cell with better connectivity may be available. While one potential solution may involve the UE requesting that the bearer be deactivated once the call ends, this may result in longercall setup if an emergency call is subsequently placed (e.g., shortly after the initial call ends).

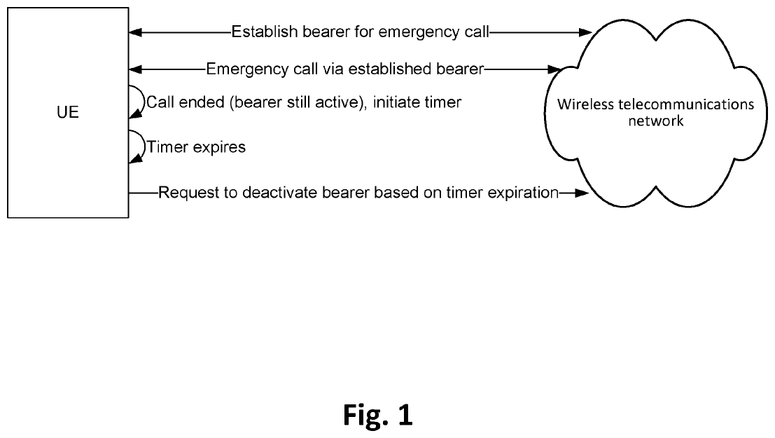

As discussed herein, a UE may, in accordance with some embodiments, mitigate or eliminate some or all of the above-identified technical problems. For instance, as shown in FIG. 1, a UE may establish a bearer (e.g., an anonymous PDN connection for emergency bearer services, herein sometimes referred to as an “emergency PDN bearer”) with a wireless telecommunications network (e.g., a network that implements voice calls over a PDN, such as VoLTE calls) for an emergency call. Once the bearer is established, an emergency call may be carried via the established bearer. Eventually, the call may end (e.g., after a caller, using the UE, hangs up) In some implementations, the bearer may, however, remain active after the call ends. In accordance with some embodiments, the UE may initiate a timer (e.g., an inactivity timer) once the call ends. The timer may count up to, or down from, 15 seconds, 30 seconds, 1 minute, 10 minutes, and/or any suitable amount of time. Once the timer expires, the UE may output a request, to the wireless telecommunications network, to deactivate the bearer that was established for the emergency call.

By proactively requesting that the bearer be deactivated, network resources (e.g., network resources associated with maintaining the active hearer) may be conserved. Additionally, waiting until the expiration of an inactivity timer, before requesting that the bearer be deactivated, may result in faster call setup if a user of the UE wishes to place another call (e.g., an emergency call) within a relatively short duration of time (e.g., before the inactivity timer expires). Furthermore, when the bearer is deactivated, the UE may be more likely to attach to cells that provide better connectivity (e.g., in situations where the emergency call has been placed in an area with limited connectivity).

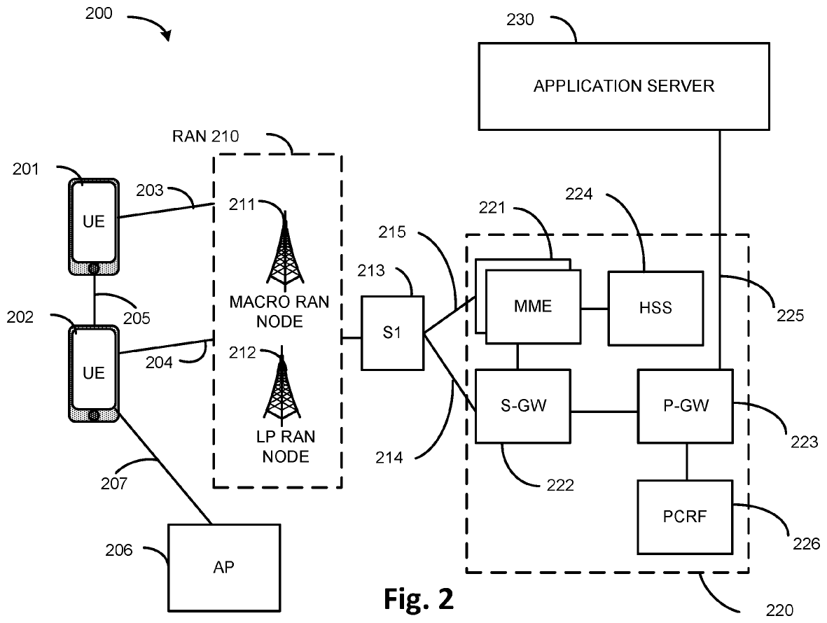

FIG. 2 illustrates an architecture of a system 200 in accordance with some embodiments. System 200 is shown to include UE 201 and UE 202. UEs 201 and 202 are illustrated as smartphones (e.g., handheld touchscreen mobile computing devices connectable to one or more cellular networks), but may also comprise any mobile or non-mobile computing device, such as Personal Data Assistants (“PDAs”), pagers, laptop computers, desktop computers, wireless handsets, or any computing device including a wireless communications interface.

In some embodiments, any of UEs 201 and 202 can comprise an Internet of Things (“IoT”) UE, which can comprise a network access layer designed for low-power IoT applications utilizing short-lived UE connections. An IoT UE can utilize technologies such as machine-to-machine (“M2M”) or machine-type communications (“MTC”) for exchanging data with an MTC server or device via a public land mobile network (“PLMN”), Proximity-Based Service (“ProSe”) or device-to-device (“D2D”) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

UEs 201 and 202 may be configured to connect (e.g., communicatively couple) with radio access network (“RAN”) 210, which may be, for example, an Evolved Universal Mobile Telecommunications System (“UMTS”) Terrestrial RAN (“E-UTRAN”), a NextGen RAN (“NG RAN”), or some other type of RAN. UEs 201 and 202 utilize connections 203 and 204, respectively, each of which may comprise a physical communications interface or layer; in this example, connections 203 and 204 are illustrated as an air interface to enable communicative coupling, and can be consistent with cellular communications protocols, such as a Global System for Mobile Communications (“GSM”) protocol, a code-division multiple access (“CDMA”) network protocol, a Push-to-Talk (“PTT”) protocol, a PTT over Cellular (“POC”) protocol, a Universal Mobile Telecommunications System (“UMTS”) protocol, a Third Generation Partnership Project (“3GPP”) Long Term Evolution (“LTE”) protocol, a fifth generation (“5G”) protocol, a New Radio (“NR”) protocol, or the like.

In this embodiment, UEs 201 and 202 may further directly exchange communication data via a ProSe interface 205. The ProSe interface 205 may alternatively be referred to as a sidelink interface comprising one or more logical channels, including but not limited to a Physical Sidelink Control Channel (“PSCCH”), a Physical Sidelink Shared Channel (“PSSCH”), a Physical Sidelink Discovery Channel (“PSDCH”), and a Physical Sidelink Broadcast Channel (“PSBCH”).

UE 202 is shown to be configured to access an access point (“AP”) 206 via connection 207. Connection 207 can comprise a local wireless connection, such as a connection consistent with any Institute of Electrical and Electronics Engineers (“IEEE”)802.11 protocol, where AP 206 may comprise a wireless (e.g., Wi-Fi®) router. In this example, AP 206 is shown to be connected to the Internet without connecting to the core network of the wireless system.

RAN 210 may include one or more access nodes that enable connections 203 and 204. These access nodes (“ANs”) can be referred to as base stations (“BSs”), NodeBs, evolved NodeBs (“eNBs”), next Generation NodeBs (“gNB”), RAN nodes, etc., and can comprise ground stations (e.g., terrestrial access points) or satellite stations providing coverage within a geographic area (e.g., a cell). RAN 210 may include one or more RAN nodes for providing macrocells (e.g., macro RAN node 211), and one or more RAN nodes for providing femtocells or picocells (e.g., cells having smaller coverage areas, smaller user capacity, or higher bandwidth compared to macrocells), such as low power (“LP”) RAN node 212.

Any of RAN nodes 211 and 212 may terminate the air interface protocol and may be the first point of contact for the UEs 201 and 202. In some embodiments, any of RAN nodes 211 and/or 212 can fulfill various logical functions for the RAN 110 including, but not limited to, radio network controller (RNC) functions such as radio bearer management, uplink and downlink dynamic radio resource management and data packet scheduling, and mobility management.

In accordance with some embodiments, UEs 201 and 202 may be configured to communicate using Orthogonal Frequency-Division Multiplexing (“OFDM”) communication signals with each other or with any of the RAN nodes 211 and 212 over a multicarrier communication channel in accordance various communication techniques, such as, but not limited to, an Orthogonal Frequency-Division Multiple Access (“OFDMA”) communication technique (e.g., for downlink communications) or a Single Carrier Frequency Division Multiple Access (“SC-FDMA”) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of RAN nodes 211 and 212 to UEs 201 and 202, while uplink transmissions may utilize similar techniques. The grid can be a time-frequency grid, called a resource grid or time-frequency resource grid, which refers to the physical resource in the downlink in each slot. Such a time-frequency plane representation may be used in OFDM systems. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (“PDSCH”) may carry user data and higher-layer signaling to UEs 201 and 202. The physical downlink control channel (“PDCCH”) may carry information about the transport format and resource allocations related to the PDSCH channel, among other information. The PDCCH also inform UEs 201 and 202 about the transport format, resource allocation, and Hybrid Automatic Repeat Request (“H-ARQ”) information related to the uplink shared channel. Downlink scheduling (assigning control and shared channel resource blocks to the UE 202 within a cell) may be performed at any of RAN nodes 211 and 212 based on channel quality information fed back from any of UEs 201 and 202. The downlink resource assignment information may be sent on the PDCCH used for (e.g., assigned to) each of UEs 201 and 202.

The PDCCH may use control channel elements (“CCEs”) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (“REGs”). Four Quadrature Phase Shift Keying (“QPSK”) symbols may be mapped to each REG. The PDCCH can be transmitted using one or more CCEs, depending on the size of the downlink control information (“DCI”) and the channel condition. Multiple (e.g., four or more) different PDCCH formats may be defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (“EPDCCH”) that uses PDSCH resources for control information transmission. The EPDCCH may be transmitted using one or more enhanced the control channel elements (“ECCEs”). Similar to above, each ECCE may correspond to nine sets of four physical resource elements known as an enhanced resource element groups (“EREGs”). An ECCE may have other numbers of EREGs in some situations.

RAN 210 is shown to be communicatively coupled to a core network (“CN”) 220 via an S1 interface 213. In embodiments, CN 220 may be an evolved packet core (“EPC”) network, a NextGen Packet Core (“NPC”) network, or some other type of CN. In this embodiment, S1 interface 213 is split into two parts: S1-U interface 214, which may carry traffic data between RAN nodes 211 and 212 and serving gateway (“S-GW”) 222, and S-mobility management entity (“MME”) interface 215, which may be a signaling interface between RAN nodes 211 and 212 and MMEs 221.

In the system shown in FIG. 2, CN 220 may include MMEs 221, S-GW 222, Packet Data Network (“PDN”) Gateway (“P-GW”) 223, and home subscriber server (“HSS”) 224. MMEs 221 may be similar in function to the control plane of legacy Serving General Packet Radio Service (“GPRS”) Support Nodes (“SGSN”). MMEs 221 may manage mobility, such as gateway selection and tracking area list management. HSS 224 may comprise a database for network users, including subscription-related information to support network entities' handling of communication sessions. CN 220 may comprise one or more HSSs 224, depending on the number of mobile subscribers, on the capacity of the equipment, on the organization of the network, etc. For example, HSS 224 may provide support for routing/roaming, authentication, authorization, naming/addressing resolution, location dependencies, etc.

S-GW 222 may terminate S1 interface 213 towards RAN 210, and route data packets between RAN 210 and the CN 220. In addition, S-GW 222 may be a local mobility anchor point for inter-RAN node handovers and also may provide an anchor for inter-3GPP mobility. Other responsibilities may include lawful intercept, charging, and policy enforcement.

P-GW 223 may terminate an SGi interface toward a PDN. P-GW 223 may route data packets between EPC network 223 and external networks such as a network including application server 230 (alternatively referred to as application function (“AF”)) via an Internet Protocol (“IP”) interface 225. Generally, application server 230 may be an element offering applications that use IP bearer resources with the core network (e.g., UMTS Packet Services (“PS”) domain, LTE PS data services, etc.). In this figure, P-GW 223 is shown to be communicatively coupled to application server 230 via IP communications interface 225. Application server 230 may also be configured to support one or more communication services (e.g., Voice-over-Internet Protocol (“VoIP”) sessions, PTT sessions, group communication sessions, social networking services, etc.) for UEs 201 and 202 via CN 220.

P-GW 223 may further be a node for policy enforcement and charging data collection. Policy and Charging Enforcement Function (“PCRF”) 226 may perform policy and charging control functions for CN 220. In a non-roaming scenario, there may be a single PCRF 226 in the Home Public Land Mobile Network (“HPLMN”) associated with a UE's Internet Protocol Connectivity Access Network (“IP-CAN”) session. In a roaming scenario with local breakout of traffic, there may be two PCRFs 226 associated with a UE's IP-CAN session: a Home PCRF (“H-PCRF”) within a HPLMN and a Visited PCRF (“V-PCRF”) within a Visited Public Land Mobile Network (“VPLMN”). PCRF 226 may be communicatively coupled to application server 230 via P-GW 223. Application server 230 may signal PCRF 226 to indicate a new service flow and select the appropriate Quality of Service (“QoS”) and charging parameters. PCRF 226 may provision this rule into a Policy and Charging Enforcement Function (“PCEF”) (not shown) with the appropriate traffic flow template (“TFT”) and QoS class identifier (“QCI”), which commences the QoS and charging as specified by application server 230.

The quantity of devices and/or networks, illustrated in FIG. 2, is provided for explanatory purposes only. In practice, system 200 may include additional devices and/or networks; fewer devices and/or networks; different devices and/or networks; or differently arranged devices and/or networks than illustrated in FIG. 2. For example, while not shown, environment 200 may include devices that facilitate or enable communication between various components shown in environment 200, such as routers, modems, gateways, switches, hubs, etc. Alternatively, or additionally, one or more of the devices of system 200 may perform one or more functions described as being performed by another one or more of the devices of system 200. Additionally, the devices of system 200 may interconnect with each other and/or other devices via wired connections, wireless connections, or a combination of wired and wireless connections. In some embodiments, one or more devices of system 200 may be physically integrated in, and/or may be physically attached to, one or more other devices of system 200. Also, while “direct” connections may be shown between certain devices in FIG. 2, some of said devices may, in practice, communicate with each other via one or more additional devices and/or networks.

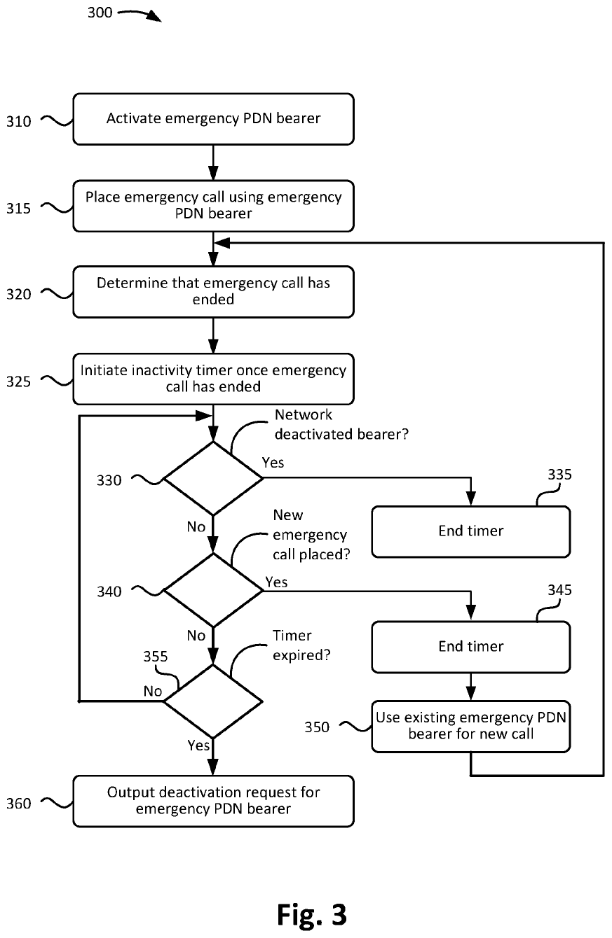

FIG. 3 illustrates an example process 300 for deactivating an emergency PDN bearer upon a UE request, where the UE requests the deactivation based on the expiration of an inactivity timer. In some embodiments, one or more of the operations described in FIG. 3 may be performed in whole, or in part, by UE 201 or UE 201 (hereinafter described in the context of UE 201 performing process 300).

As shown, process 300 may include activating (at 310) an emergency PDN bearer. For example, UE 201 may communicate with one or more devices of a wireless telecommunications network (e.g., an LTE network and/or some other type of network) to establish the emergency PDN bearer. UE 201 may establish the emergency PDN bearer in response to an emergency call being placed (e.g., by a user of UE 201). The activating and/or establishing of the emergency PDN bearer may be based on an anonymous request from UE 201 (e.g., where UE 201 does not provide authentication credentials). The anonymous request may be supported by the network for emergency calls (e.g., calls to certain numbers associated with emergency services).

Once the emergency PDN bearer has been established, the call may be placed (at 315) and carried via the emergency PDN bearer. Eventually, UE 201 may determine (at 320) that the emergency call has ended. For example, a user of UE 201 may hang up, or a called party may terminate the call.

Process 300 may further include initiating (at 325) an inactivity timer once the emergency call has ended. For example, UE 201 may begin counting up to, or down from, a pre-selected amount of time (e.g., 15 seconds, 30 seconds, 1 minute, 10 minutes, etc.) based on determining (at 320) that the emergency call (e.g., the call to a telephone number associated with emergency services, using the emergency PDN bearer).

While the inactivity timer is running, process 300 may include determining (at 330) whether the network has deactivated the emergency PDN bearer. If the network has deactivated the bearer (at 330—YES), then UE 201 may end (at 335) the inactivity timer. For example, UE 201 may cease counting, and the inactivity timer may be reset e.g., to its initial value) for future use.

If the network has not deactivated the bearer while the inactivity timer is running (at 330—NO), then UE 201 may determine (at 340) whether a new emergency call has been placed. For example, UE 201 may determine whether a new emergency has been placed (e.g., to the same telephone number as the initial call, or to another telephone number associated with emergency services). If a new emergency call has been placed while the inactivity timer is running (at 340—YES), then UE 201 may end (at 345) the inactivity timer. For example, UE 201 may cease counting, and the inactivity timer may be reset. Additionally, UE 201 may use (at 350) the existing emergency PDN bearer (e.g., as activated at block 310) for the new call Once the new call ends (at 320), process 300 may continue in a similar manner (e.g., the inactivity timer may be initiated again (at 325)).

If, on the other hand, a new emergency call is not placed while the inactivity timer is running (at 340—NO), then UE 201 may determine (at 355) whether the inactivity timer has expired, while the emergency PDN bearer is still active. If the timer has not expired and the PDN bearer is still active (at 355—NO), then UE 201 may continue to monitor whether the network has deactivated the emergency PDN bearer (at 330) and/or whether a new emergency call has been placed (e.g., at 340).

If the inactivity timer has expired and the emergency PDN bearer is still active (at 355—YES), then UE 201 may output (at 360) a deactivation request for the emergency PDN bearer. For example, as described below, UE 201 may output the deactivation request to the network, which may cause the network to deactivate the emergency PDN bearer, thus freeing up resources that were used to keep the emergency PDN bearer active.

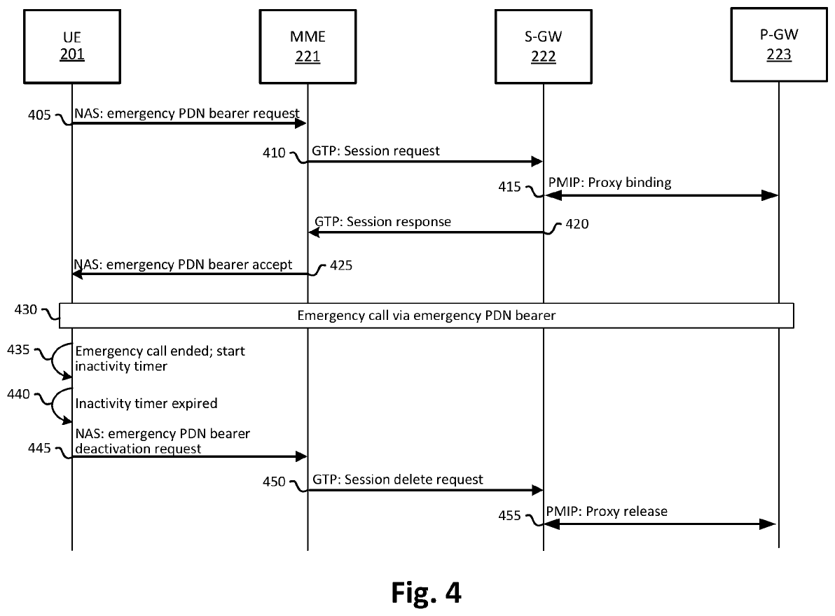

FIG. 4 shows some of the operations described above, with respect to FIG. 3, in greater details. As shown, UE 201 may output (at 405) a Non-Access Stratum (“NAS”) message to MME 221, requesting the establishment of an emergency PDN bearer. This message may be output by UE 201 based on, for example, a user of UE 201 dialing a telephone number associated with emergency services. Based on receiving the NAS message, MME 221 may output (at 410) a GPRS Tunneling Protocol (“GTP”) session request to S-GW 222. S-GW 222 may send (at 415) a Proxy Mobile IPv6 (“PMIP”) proxy binding request to P-GW 223, which may be used by P-GW 223 to facilitate the establishment of the requested PDN bearer. S-GW 222 may output (at 420) a GTP message with a response indicating that the session has been created to MME 221, and MME 221 may output (at 425) a NAS message to UE 201, indicating that the requested PDN bearer has been established.

Once the emergency PDN bearer has been established, the emergency call may be carried (at 430) via the bearer. UE 201 may detect (at 435) that the emergency call has ended, and may start an inactivity timer based on detecting that the call has ended. Once the inactivity timer expires (at 440), UE 201 may output (at 445) a NAS message requesting that the emergency PDN bearer be deactivated Based on receiving this message, MME 221 may output (at 450) a GTP session delete request to S-GW 222, and S-GW 222 may output (at 455) a PMIP: proxy release message to P-GW 223. Based on the proxy release message, P-GW 223 may deactivate previously established emergency PDN bearer.

As used herein, the term “circuitry,” “processing circuitry,” or “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

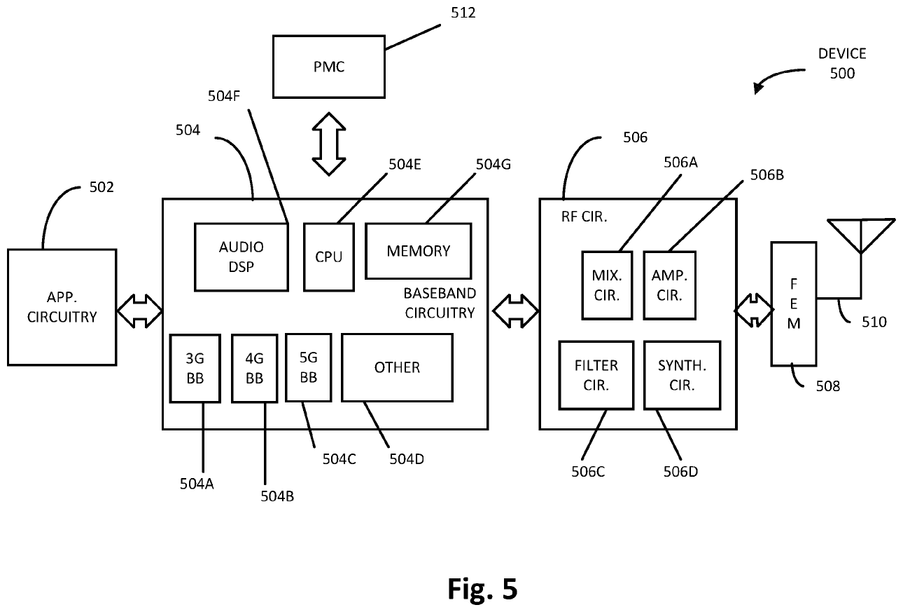

Embodiments described herein may be implemented into a system using any suitably configured hardware and/or software. FIG. 5 illustrates example components of a device 500 in accordance with some embodiments. In some embodiments, device 500 may include application circuitry 502, baseband circuitry 504, Radio Frequency (“RF”) circuitry 506, front-end module (“FEM”) circuitry 508, one or more antennas 510, and power management circuitry (“PMC”) 512 coupled together at least as shown. The components of the illustrated device 500 may be included in a UE or a RAN node. In some embodiments, device 500 may include less elements (e.g., a RAN node may not utilize application circuitry 502, and instead include a processor/controller to process IP data received from an EPC). In some embodiments, device 500 may include additional elements such as, for example, memory/storage, display, camera, sensor, or input/output (“I/O”) interface. In other embodiments, the components described below may be included in more than one device (e.g., said circuitries may be separately included in more than one device for Cloud-RAN (“C-RAN”) implementations).

The application circuitry 502 may include one or more application processors. For example, the application circuitry 502 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on device 500. In some embodiments, processors of application circuitry 502 may process IP data packets received from an EPC.

The baseband circuitry 504 may include circuitry such as, but not limited to, one or more single-core or multi-core processors. The baseband circuitry 504 may include one or more baseband processors or control logic to process baseband signals received from a receive signal path of the RF circuitry 506 and to generate baseband signals for a transmit signal path of the RF circuitry 506. Baseband processing circuitry 504 may interface with the application circuitry 502 for generation and processing of the baseband signals and for controlling operations of the RF circuitry 506. For example, in some embodiments, the baseband circuitry 504 may include a 3G baseband processor 504A, a 4G baseband processor 504B, a 5G baseband processor 504C, or other baseband processor(s) 504D for other existing generations, generations in development or to be developed in the future (e.g., second generation (“2G”), sixth generation (“6G”), etc.). The baseband circuitry 504 (e.g., one or more of baseband processors 504A-D) may handle various radio control functions that enable communication with one or more radio networks via the RF circuitry 506. In other embodiments, some or all of the functionality of baseband processors 504A-D may be included in modules stored in the memory 504G and executed via a Central Processing Unit (“CPU”) 504E. The radio control functions may include, but are not limited to, signal modulation/demodulation, encoding/decoding, radio frequency shifting, etc. In some embodiments, modulation/demodulation circuitry of the baseband circuitry 504 may include Fast-Fourier Transform (“FFT”), precoding, or constellation mapping/demapping functionality. In some embodiments, encoding/decoding circuitry of the baseband circuitry 504 may include convolution, tail-biting convolution, turbo, Viterbi, or Low-Density Parity Check (“LDPC”) encoder/decoder functionality. Embodiments of modulation/demodulation and encoder/decoder functionality are not limited to these examples and may include other suitable functionality in other embodiments.

In some embodiments, the baseband circuitry 504 may include one or more audio digital signal processor(s) (“DSP”) 504F. Audio DSP(s) 504F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 504 and the application circuitry 502 may be implemented together such as, for example, on a system on a chip (“SOC”).

In some embodiments, the baseband circuitry 504 may provide for communication compatible with one or more radio technologies. For example, in some embodiments, the baseband circuitry 504 may support communication with an E-UTRAN or other wireless metropolitan area networks (“WMAN”), a wireless local area network (“WLAN”), a wireless personal area network (“WPAN”). Embodiments in which the baseband circuitry 504 is configured to support radio communications of more than one wireless protocol may be referred to as multi-mode baseband circuitry.

RF circuitry 506 may enable communication with wireless networks using modulated electromagnetic radiation through a non-solid medium. In various embodiments, the RF circuitry 506 may include switches, filters, amplifiers, etc. to facilitate the communication with the wireless network. RF circuitry 506 may include a receive signal path which may include circuitry to down-convert RF signals received from the FEM circuitry 508 and provide baseband signals to the baseband circuitry 504. RF circuitry 506 may also include a transmit signal path which may include circuitry to up-convert baseband signals provided by the baseband circuitry 504 and provide RF output signals to the FEM circuitry 508 for transmission.

In some embodiments, the receive signal path of the RF circuitry 506 may include mixer circuitry 506a, amplifier circuitry 506b and filter circuitry 506c. In some embodiments, the transmit signal path of the RF circuitry 506 may include filter circuitry 506c and mixer circuitry 506a. RF circuitry 506 may also include synthesizer circuitry 506d for synthesizing a frequency for use by the mixer circuitry 506a of the receive signal path and the transmit signal path. In some embodiments, the mixer circuitry 506a of the receive signal path may be configured to down-convert RF signals received from the FEM circuitry 508 based on the synthesized frequency provided by synthesizer circuitry 506d. The amplifier circuitry 506b may be configured to amplify the down-converted signals and the filter circuitry 506c may be a low-pass filter (“LPF”) or band-pass filter (“BPF”) configured to remove unwanted signals from the down-converted signals to generate output baseband signals. Output baseband signals may be provided to the baseband circuitry 504 for further processing. In some embodiments, the output baseband signals may be zero-frequency baseband signals, although this is not a requirement. In some embodiments, mixer circuitry 506a of the receive signal path may comprise passive mixers, although the scope of the embodiments is not limited in this respect.

In some embodiments, the mixer circuitry 506a of the transmit signal path may be configured to up-convert input baseband signals based on the synthesized frequency provided by the synthesizer circuitry 506d to generate RF output signals for the FEM circuitry 508. The baseband signals may be provided by the baseband circuitry 504 and may be filtered by filter circuitry 506c.

In some embodiments, the mixer circuitry 506a of the receive signal path and the mixer circuitry 506a of the transmit signal path may include two or more mixers and may be arranged for quadrature downconversion and upconversion, respectively. In some embodiments, the mixer circuitry 506a of the receive signal path and the mixer circuitry 506a of the transmit signal path may include two or more mixers and may be arranged for image rejection (e.g., Hartley image rejection). In some embodiments, the mixer circuitry 506a of the receive signal path and the mixer circuitry 506a may be arranged for direct downconversion and direct upconversion, respectively. In some embodiments, the mixer circuitry 506a of the receive signal path and the mixer circuitry 506a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 506 may include analog-to-digital converter (“ADC”) and digital-to-analog converter (“DAC”) circuitry and the baseband circuitry 504 may include a digital baseband interface to communicate with the RF circuitry 506. In some dual-mode embodiments, a separate radio IC circuitry may be provided for processing signals for each spectrum, although the scope of the embodiments is not limited in this respect.

In some embodiments, the synthesizer circuitry 506d may be a fractional-N synthesizer or a fractional N/N+1 synthesizer, although the scope of the embodiments is not limited in this respect as other types of frequency synthesizers may be suitable. For example, synthesizer circuitry 506d may be a delta-sigma synthesizer, a frequency multiplier, or a synthesizer comprising a phase-locked loop with a frequency divider.

Synthesizer circuitry 506d may be configured to synthesize an output frequency for use by the mixer circuitry 506a of the RF circuitry 506 based on a frequency input and a divider control input. In some embodiments, the synthesizer circuitry 506d may be a fractional N/N+1 synthesizer.

In some embodiments, frequency input may be provided by a voltage controlled oscillator (“VCO”), although that is not a requirement. Divider control input may be provided by either baseband circuitry 504 or applications processor 502 depending on the desired output frequency. In some embodiments, a divider control input (e.g., N) may be determined from a look-up table based on a channel indicated by the applications processor 502.

Synthesizer circuitry 506d of the RF circuitry 506 may include a divider, a delay-locked loop (“DLL”), a multiplexer and a phase accumulator. In some embodiments, the divider may be a dual modulus divider (“DMD”) and the phase accumulator may be a digital phase accumulator (“DPA”). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 506d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (“fLO”). In some embodiments, the RF circuitry 506 may include an IQ/polar converter.

FEM circuitry 508 may include a receive signal path which may include circuitry configured to operate on RF signals received from one or more antennas 510, amplify the received signals and provide the amplified versions of the received signals to the RF circuitry 506 for further processing. FEM circuitry 508 may also include a transmit signal path which may include circuitry configured to amplify signals for transmission provided by the RF circuitry 506 for transmission by one or more of the one or more antennas 510. In various embodiments, the amplification through the transmit or receive signal paths may be done solely in the RF circuitry 506, solely in the FEM 508, or in both the RF circuitry 506 and the FEM 508.

In some embodiments, the FEM circuitry 508 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 506). The transmit signal path of the FEM circuitry 508 may include a power amplifier (“PA”) to amplify input RF signals (e.g., provided by RF circuitry 506), and one or more filters to generate RF signals for subsequent transmission (e.g., by one or more of the one or more antennas 510).

In some embodiments, PMC 512 may manage power provided to the baseband circuitry 504. In particular. PMC 512 may control power-source selection, voltage scaling, battery charging, or DC-to-DC conversion. PMC 512 may often be included when device 500 is capable of being powered by a battery (for example, when the device is included in a UE). PMC 512 may increase the power conversion efficiency while providing desirable implementation size and heat dissipation characteristics.

FIG. 5 shows PMC 512 coupled only with baseband circuitry 504. However, in other embodiments, PMC 512 may be additionally or alternatively coupled with, and perform similar power management operations for, other components such as, but not limited to, application circuitry 502, RF circuitry 506, or FEM 508.

In some embodiments, the PMC 512 may control, or otherwise be part of, various power saving mechanisms of device 500. For example, if device 500 is in an RRC_Connected state, where it is still connected to the RAN node as it expects to receive traffic shortly, then it may enter a state known as Discontinuous Reception Mode (“DRX”) after a period of inactivity. During this state, device 500 may power down for brief intervals of time and thus save power.

If there is no data traffic activity for an extended period of time, then device 500 may transition off to an RRC_Idle state, where it disconnects from the network and does not perform operations such as channel quality feedback, handover, etc. Device 500 goes into a very low power state and it performs paging where again it periodically wakes up to listen to the network and then powers down again. Device 500 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 502 and processors of the baseband circuitry 504 may be used to execute elements of one or more instances of a protocol stack Fig. or example, processors of the baseband circuitry 504, alone or in combination, may be used execute Layer 3, Layer 2, or Layer 1 functionality, while processors of the application circuitry 504 may utilize data (e.g., packet data) received from these layers and further execute Layer 4 functionality (e.g., transmission communication protocol (“TCP”) and user datagram protocol (“UDP”) layers). As referred to herein, Layer 3 may comprise a radio resource control (“RRC”) layer, described in further detail below. As referred to herein, Layer 2 may comprise a medium access control (“MAC”) layer, a radio link control (“RLC”) layer, and a packet data convergence protocol (“PDCP”) layer, described in further detail below. As referred to herein, Layer 1 may comprise a physical (“PHY”) layer of a UE/RAN node, described in further detail below.

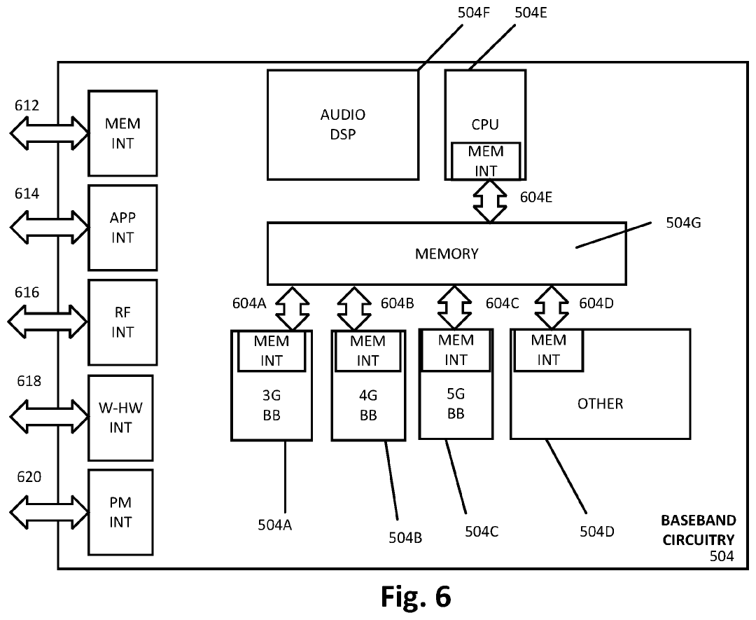

FIG. 6 illustrates example interfaces of baseband circuitry in accordance with some embodiments. As discussed above, the baseband circuitry 504 of FIG. 5 may comprise processors 604A-604E and a memory 604G utilized by said processors. Each of the processors 604A-604E may include a memory interface, respectively, to send/receive data to/from the memory 604G.

The baseband circuitry 604 may further include one or more interfaces to communicatively couple to other circuitries/devices, such as a memory interface 612 (e.g., an interface to send/receive data to/from memory external to the baseband circuitry 504), an application circuitry interface 614 (e.g., an interface to send/receive data to/from the application circuitry 502 of FIG. 5), an RF circuitry interface 618 (e.g., an interface to send/receive data to/from RF circuitry 506 of FIG. 5), a wireless hardware connectivity interface 616 (e.g., an interface to send/receive data to/from Near Field Communication (“NFC”) components, Bluetooth® components (e.g., Bluetooth® Low Energy), Wi-Fi® components, and other communication components), and a power management interface 620 (e.g., an interface to send/receive power or control signals to/from the PMC 512).

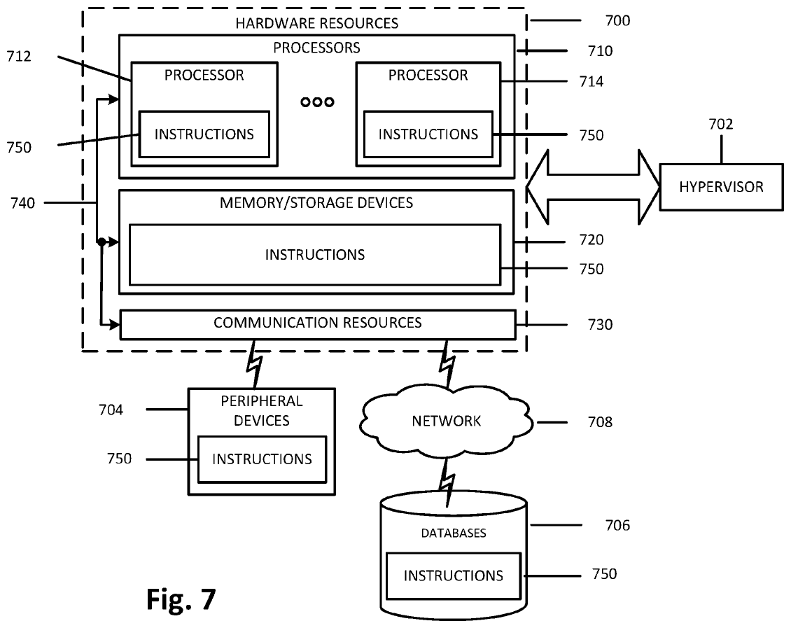

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700

The processors 710 (e.g., a CPU), a reduced instruction set computing (“RISC”) processor, a complex instruction set computing (“CISC”) processor, a graphics processing unit (“GPU”), a digital signal processor (“DSP”) such as a baseband processor, an ASIC, a radio-frequency integrated circuit (“RFTC”), another processor, or any suitable combination thereof) may include, for example, a processor 712 and a processor 714.

The memory/storage devices 720 may include main memory, disk storage, or any suitable combination thereof. The memory/storage devices 720 may include, but are not limited to any type of volatile or non-volatile memory such as dynamic random-access memory (“DRAM”), static random-access memory (“SRAM”), erasable programmable read-only memory (“EPROM”), electrically erasable programmable read-only memory (“EEPROM”), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (“USB”)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

A number of examples, relating to embodiments of the techniques described above, will next be given. A first example includes a user equipment (“UE”), comprising: a non-transitory computer-readable medium storing processor-executable instructions; and one or more processors configured to execute the processor-executable instructions, wherein executing the processor-executable instructions causes the one or more processors to: establish a Packet Data Network (“PDN”) connection for emergency bearer services between the UE and a wireless telecommunications network; place a call via the established PDN connection; determine, after the call is placed, that the call has ended, activate, based on determining that the call has ended, an inactivity timer; determine, after activating the inactivity timer, that the inactivity timer has ended; determine, after determining that the inactivity timer has ended, that the PDN connection is still active; and output, based on determining that the PDN connection is still active when the inactivity timer has ended, a request to the network to deactivate the PDN connection.

A second example includes the UE of example 1, wherein the inactivity timer counts up from zero to a particular value, wherein the inactivity timer expires when the inactivity timer reaches the particular value.

A third example includes the UE of example 1, wherein the inactivity timer counts down from a particular value to zero, wherein the inactivity timer expires when the inactivity timer reaches zero.

A fourth example includes the UE of example 1, wherein the PDN connection is established without the UE providing authentication information to the network as part of the establishment of the PDN connection.

A fifth example includes the UE of example 1, wherein executing the processor-executable instructions further causes the one or more processors to: receive a request to place another call while the inactivity timer is running; place the other call via the established PDN connection; stop the inactivity timer when placing the other call; reset the inactivity timer to an initial value when stopping the inactivity timer; and restart the inactivity timer, from the initial value, when the other call ends.

A sixth example includes the UE of example 1, wherein the processor-executable instructions, to output the request to deactivate the emergency PDN connection, include processor-executable instructions to: output a Non-Access Stratum (“NAS”) PDN bearer deactivation request.

A seventh example includes the UE of example 6, wherein the processor-executable instructions, to output the NAS PDN bearer deactivation request, include processor-executable instructions to output the NAS PDN bearer deactivation request to a Mobility Management Entity (“MME”) of the wireless telecommunications network.

An eight example includes the UE of example 1, wherein the call is a Voice over Long-Term Evolution (“VoLTE”) call.

A ninth example includes a non-transitory computer-readable medium storing a set of processor-executable instructions, which, when executed by one or more processors of a user equipment (“UE”), cause the one or more processors to: establish an emergency Packet Data Network (“PDN”) bearer between the UE and a wireless telecommunications network; place a call via the emergency PDN bearer; determine, after the call is placed, that the call has ended; activate, based on determining that the call has ended, an inactivity timer; determine, after activating the inactivity timer, that the inactivity timer has ended; determine, after determining that the inactivity timer has ended, that the emergency PDN bearer is still active; output, based on determining that the emergency bearer is still active when the inactivity timer has ended, a request to the network to deactivate the emergency PDN bearer.

A tenth example includes the non-transitory computer-readable medium of example 9, wherein the inactivity timer counts up from zero to a particular value, wherein the inactivity timer expires when the inactivity timer reaches the particular value.

An eleventh example includes the non-transitory computer-readable medium of example 9, wherein the inactivity timer counts down from a particular value to zero, wherein the inactivity timer expires when the inactivity timer reaches zero.

A twelfth example includes the non-transitory computer-readable medium of example 9, wherein the PDN bearer is established without the UE providing authentication information to the network.

A thirteenth example includes the non-transitory computer-readable medium of example 9, wherein the processor-executable instructions further include processor-executable instructions to: receive a request to place another call while the inactivity timer is running, place the other call via the established emergency PDN bearer, stop the inactivity timer when placing the other call; reset the inactivity timer to an initial value when stopping the inactivity timer, and restart the inactivity timer, from the initial value, when the other call ends.

A fourteenth example includes the non-transitory computer-readable medium of example 9, wherein the processor-executable instructions, to output the request to deactivate the emergency PDN bearer, include processor-executable instructions to output a Non-Access Stratum (“NA S”) PDN bearer deactivation request.

A fifteenth example includes the non-transitory computer-readable medium of example 14, wherein the processor-executable instructions, to output the NAS PDN bearer deactivation request, include processor-executable instructions to output the NAS PDN bearer deactivation request to a Mobility Management Entity (“MME”) of the wireless telecommunications network.

A sixteenth example includes the non-transitory computer-readable medium of example 9, wherein the call is a Voice over Long-Term Evolution (“VoLTE”) call.

A seventeenth example includes a user equipment (“UE”), comprising a non-transitory computer-readable medium storing processor-executable instructions; and one or more processors configured to execute the processor-executable instructions, wherein executing the processor-executable instructions causes the one or more processors to: anonymously request establishment of a Packet Data Network (“PDN”) bearer, associated with emergency bearer services, between the UE and a wireless telecommunications network; place, by the UE, a call via the PDN bearer, determine, after the call is placed, that the call has ended; activate, based on determining that the call has ended, an inactivity timer; determine, by the UE and after activating the inactivity timer, that the inactivity timer has expired; determine, by the UE and after determining that the inactivity timer has expired, that the PDN bearer is still active; output, based on determining that the emergency bearer is still active when the inactivity timer has ended, a request to the network to deactivate the y PDN bearer.

An eighteenth example includes the UE of example 17, wherein the inactivity timer counts up from zero to a particular value, wherein the inactivity timer expires when the inactivity timer reaches the particular value.

A nineteenth example includes the UE of example 17, wherein the inactivity timer counts down from a particular value to zero, wherein the inactivity timer expires when the inactivity timer reaches zero.

A twentieth example includes the UE of example 17, wherein the PDN bearer is established anonymously, without the UE providing authentication information to the network.

A twenty-first example includes the UE of example 17, wherein executing the processor-executable instructions further causes the one or more processors to: receive a request to place another call while the inactivity timer is running, place the other call via the established PDN bearer; stop the inactivity timer when placing the other call; reset the inactivity timer to an initial value when stopping the inactivity timer; and restart the inactivity timer, from the initial value, when the other call ends.

A twenty-second example includes the UE of example 17, wherein executing the processor-executable instructions, to output the request to deactivate the PDN bearer, further causes the one or more processors to output a Non-Access Stratum (“NAS”) PDN bearer deactivation request.

A twenty-third example includes the UE of example 22, wherein the processor-executable instructions, to output the NAS PDN bearer deactivation request, further causes the one or more processors to output the NAS PDN bearer deactivation request to a Mobility Management Entity (“MME”) of the wireless telecommunications network.

A twenty-fourth example includes the UE of example 17, wherein the call is a Voice over Long-Term Evolution (“VoLTE”) call.

In the preceding specification, various embodiments have been described with reference to the accompanying drawings. It will, however, be evident that various modifications and changes may be made thereto, and additional embodiments may be implemented, without departing from the broader scope as set forth in the claims that follow. The specification and drawings are accordingly to be regarded in an illustrative rather than restrictive sense.

For example, while series of signals and/or operations have been described with regard to FIGS. 3 and 4, the order of the signals/operations may be modified in other implementations. Further, non-dependent signals may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to be limiting. In fact, many of these features may be combined in ways not specifically recited in the claims and/or disclosed in the specification.

No element, act, or instruction used in the present application should be construed as critical or essential unless explicitly described as such An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used.

1-24. (canceled)

25. A user equipment (UE), comprising:
a non-transitory computer-readable medium storing processor-executable instructions; and
one or more processors configured to execute the processor-executable instructions, wherein executing the processor-executable instructions causes the one or more processors to:
establish a Packet Data Network (PDN) connection for emergency bearer services between the UE and a wireless telecommunications network;
place a call via the established PDN connection;
determine, after the call is placed, that the call has ended;
activate, based on determining that the call has ended, an inactivity timer;
determine, after activating the inactivity timer, that the inactivity timer has ended;
determine, after determining that the inactivity timer has ended, that the PDN connection is still active; and
output, based on determining that the PDN connection is still active when the inactivity timer has ended, a request to the network to deactivate the PDN connection.

26. The UE of claim 25, wherein the inactivity timer counts up from zero to a particular value, wherein the inactivity timer expires when the inactivity timer reaches the particular value.

27. The UE of claim 25, wherein the inactivity timer counts down from a particular value to zero, wherein the inactivity timer expires when the inactivity timer reaches zero.

28. The UE of claim 25, wherein the PDN connection is established without the UE providing authentication information to the network as part of the establishment of the PDN connection.

29. The UE of claim 25, wherein executing the processor-executable instructions further causes the one or more processors to:
receive a request to place another call while the inactivity timer is running;
place the other call via the established PDN connection;
stop the inactivity timer when placing the other call;
reset the inactivity timer to an initial value when stopping the inactivity timer; and
restart the inactivity timer, from the initial value, when the other call ends.

30. The UE of claim 25, wherein the processor-executable instructions, to output the request to deactivate the emergency PDN connection, include processor-executable instructions to:
output a Non-Access Stratum (NAS) PDN bearer deactivation request.

31. The UE of claim 30, wherein the processor-executable instructions, to output the NAS PDN bearer deactivation request, include processor-executable instructions to output the NAS PDN bearer deactivation request to a Mobility Management Entity (MME) of the wireless telecommunications network.

32. The UE of claim 25, wherein the call is a Voice over Long-Term Evolution (VoLTE) call.

33. A non-transitory computer-readable medium storing a set of processor-executable instructions, which, when executed by one or more processors of a user equipment (UE), cause the one or more processors to:
establish an emergency Packet Data Network (PDN) bearer between the UE and a wireless telecommunications network;
place a call via the emergency PDN bearer;
determine, after the call is placed, that the call has ended;
activate, based on determining that the call has ended, an inactivity timer;
determine, after activating the inactivity timer, that the inactivity timer has ended;
determine, after determining that the inactivity timer has ended, that the emergency PDN bearer is still active; and
output, based on determining that the emergency bearer is still active when the inactivity timer has ended, a request to the network to deactivate the emergency PDN bearer.

34. The non-transitory computer-readable medium of claim 33, wherein the inactivity timer counts up from zero to a particular value, wherein the inactivity timer expires when the inactivity timer reaches the particular value.

35. The non-transitory computer-readable medium of claim 33, wherein the inactivity timer counts down from a particular value to zero, wherein the inactivity timer expires when the inactivity timer reaches zero.

36. The non-transitory computer-readable medium of claim 33, wherein the PDN bearer is established without the UE providing authentication information to the network.

37. The non-transitory computer-readable medium of claim 33, wherein the processor-executable instructions further include processor-executable instructions to:
receive a request to place another call while the inactivity timer is running;
place the other call via the established emergency PDN bearer;
stop the inactivity timer when placing the other call;
reset the inactivity timer to an initial value when stopping the inactivity timer; and
restart the inactivity timer, from the initial value, when the other call ends.

38. The non-transitory computer-readable medium of claim 33, wherein the processor-executable instructions, to output the request to deactivate the emergency PDN bearer, include processor-executable instructions to output a Non-Access Stratum (NAS) PDN bearer deactivation request.

39. The non-transitory computer-readable medium of claim 38, wherein the processor-executable instructions, to output the NAS PDN bearer deactivation request, include processor-executable instructions to output the NAS PDN bearer deactivation request to a Mobility Management Entity (MME) of the wireless telecommunications network.

40. The non-transitory computer-readable medium of claim 33, wherein the call is a Voice over Long-Term Evolution (VoLTE) call.

41. A user equipment (UE), comprising:
a non-transitory computer-readable medium storing processor-executable instructions; and
one or more processors configured to execute the processor-executable instructions, wherein executing the processor-executable instructions causes the one or more processors to:
anonymously request establishment of a Packet Data Network (PDN) bearer, associated with emergency bearer services, between the UE and a wireless telecommunications network;
place, by the UE, a call via the PDN bearer;
determine, after the call is placed, that the call has ended;
activate, based on determining that the call has ended, an inactivity timer;
determine, by the UE and after activating the inactivity timer, that the inactivity timer has expired;
determine, by the UE and after determining that the inactivity timer has expired, that the PDN bearer is still active; and
output, based on determining that the emergency bearer is still active when the inactivity timer has ended, a request to the network to deactivate the y PDN bearer.

42. The UE of claim 41, wherein the inactivity timer counts up from zero to a particular value, wherein the inactivity timer expires when the inactivity timer reaches the particular value.

43. The UE of claim 41, wherein the inactivity timer counts down from a particular value to zero, wherein the inactivity timer expires when the inactivity timer reaches zero.

44. The UE of claim 41, wherein the PDN bearer is established anonymously, without the UE providing authentication information to the network.

45. The UE of claim 41, wherein executing the processor-executable instructions further causes the one or more processors to:
receive a request to place another call while the inactivity timer is running;
place the other call via the established PDN bearer;
stop the inactivity timer when placing the other call;
reset the inactivity timer to an initial value when stopping the inactivity timer; and
restart the inactivity timer, from the initial value, when the other call ends.

46. The UE of claim 41, wherein executing the processor-executable instructions, to output the request to deactivate the PDN bearer, further causes the one or more processors to output a Non-Access Stratum (NAS) PDN bearer deactivation request.

47. The UE of claim 46, wherein the processor-executable instructions, to output the NAS PDN bearer deactivation request, further causes the one or more processors to output the NAS PDN bearer deactivation request to a Mobility Management Entity (MME) of the wireless telecommunications network.

48. The UE of claim 41, wherein the call is a Voice over Long-Term Evolution (VoLTE) call.
